(19) United States
(12) Patent Application Publication
(10) Pub. No.: US 2011/0181429 A1
(43) Pub. Date: Jul. 28, 2011

(54) VOICE NOTIFICATION CIRCUIT AND ELECTRONIC DEVICE USING THE SAME

(75) Inventors: He-Ping Chen, Shenzhen City (CN); Kai Dong, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-cheng (TW)

(21) Appl. No.: 12/758,776

(22) Filed: Apr. 12, 2010

(30) Foreign Application Priority Data
Jan. 22, 2010 (CN) 201020301219.2

(51) Int. Cl. G08B 21/00

(52) U.S. Cl. 340/636.1

(57) ABSTRACT

A voice notification circuit includes a plurality of comparison circuits, a plurality of switch circuits, a plurality of resistors and a plurality of voice storage circuits. The comparison circuits compare power levels of wireless signals to a plurality of reference voltage ranges, and output a plurality of logic control signals. The switch circuits are connected to the comparison circuits respectively to switch on/off based on the logic control signals. The resistors turn the switch circuits on. The voice storage circuits store the audio sounds. When the power levels of the wireless signals fall in one of the reference voltage ranges, the corresponding switch circuit is off and an audio signal can be output.

### BACKGROUND

1. Technical Field

Embodiments of the present disclosure relates to a voice notification circuit that indicates power levels of wireless signals and an electronic device using the same.

2. Description of Related Art

In general, Internet browsing is available using electronic devices, such as notebook computers, and mobile phones, for example. Most of the electronic devices connect to the Internet via access points (APs), and show strength of current wireless signals received from the APs via graphic interfaces on displays thereof, allowing selection of a location that provides optimum transmission. However, such location may not be practical sometimes, and antennas of the APs may need to be adjusted. When the antennas are adjusted, the strength of the wireless signals via the graphic interfaces on the displays cannot be seen. Accurate measurement of received wireless signals cannot be determined precisely, causing inconvenience.

### BRIEF DESCRIPTION OF THE DRAWINGS

FIG. 1 is a block diagram of one embodiment of an electronic device; and

FIG. 2 is a detailed circuit diagram of one embodiment of a voice notification circuit utilized in an electronic device of FIG. 1.

### DETAILED DESCRIPTION

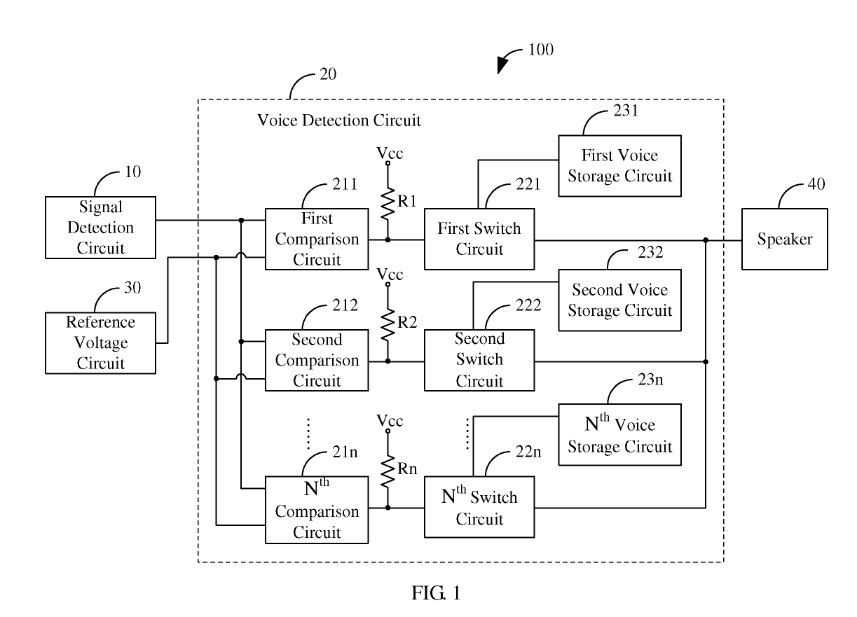

FIG. 1 is a block diagram of one embodiment of an electronic device 100 of the present disclosure. The electronic device 100 generates audio signals that indicate different power levels of wireless signal received from wireless devices, such as access points (APs). The electronic device 100 comprises a signal measurement circuit 10, a voice notification circuit 20, a reference voltage circuit 30, and a speaker 40. The signal measurement circuit 10 measures the power levels of the wireless signals and converts them into voltage signals. For example, the measurement circuit 10 outputs different voltage signals when the power levels of the wireless signals change from −60 dBm to −30 dBm. The voice notification circuit 20 converts the voltage signals into the audio signals for output to the speaker 40. The reference voltage circuit 30 provides a plurality of reference voltages to the voice notification circuit 20 to form a plurality of reference voltage ranges.

In one embodiment, the voice notification circuit 20 comprises comparison circuits 211, 212, . . . , 21n, switch circuits 221, 222, . . . , 22n, voice storage circuits 231, 232, . . . , 23n and resistors R1, R2, . . . , Rn. The number n can be a positive integer.

The comparison circuits 211, 212, . . . , 21n receive the voltage signals output from the signal measurement circuit 10, and compare the voltage signals to the reference voltage ranges and corresponding output logic control signals. The switch circuits 221, 222, . . . , 22n are connected to the comparison circuits 211, 212, . . . , 21n respectively, to switch on/off according to the logic control signals output from the comparison circuits 211, 212, . . . , 21n.

Each of the resistors R1, R2, . . . , Rn has one end receiving an external power source Vcc and the other end connected to a common node of the corresponding comparison circuit and the switch circuit. For example, the resistor R1 has one end receiving the external power source Vcc and the other end connected to a common node of the comparison circuit 211 and the switch circuit 221, to turn the switch circuit 221 on; the resistor R2 has one end also receiving the external power source Vcc and the other end connected to a common node of the comparison circuit 212 and the switch circuit 222, to turn the switch circuit 222 on; and so on through to the resistor Rn with one end also receiving the external power source Vcc and the other end connected to a common node of the comparison circuit 21n and the switch circuit 22n, to turn the switch circuit 22n on.

The voice storage circuits 231, 232, . . . , 23n are connected to the switch circuits 221, 222, . . . , 22n respectively, to store the audio signals. The audio signals can be a same signal at different frequencies, or different signals at a same frequency, which can be changed based on actual requirements. In one embodiment, the audio signals of the present disclosure are the same signal at different frequencies (such as “di”, “didi”, . . . , “didi..di”). Specifically, the frequency of the audio signal increases as the power levels of the wireless signals strengthen.

In one embodiment, the reference voltage circuit 30 provides the different reference voltage ranges to the comparison circuits 211, 212, . . . , 21n respectively. Each comparison circuit compares the received voltage signals to an individual reference voltage range, and outputs to a corresponding logic control signal. The switch circuits 221, 222, . . . , 22n can switch on/off according to the logic control signal. Thus, the speaker 40 outputs the audio signals stored in the voice storage circuits 231, 232, . . . , 23n to notify the users the power level of the wireless signals, which is convenient.

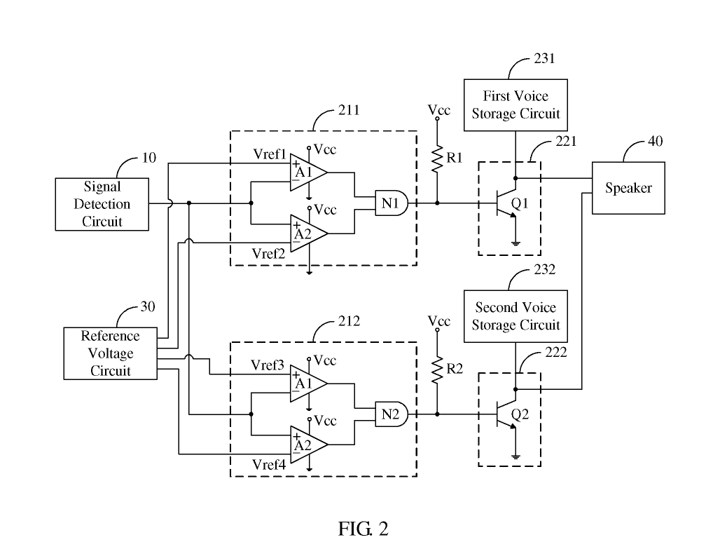

FIG. 2 is a detailed circuit of the voice notification circuit 20 of FIG. 1 of the present disclosure. In order to describe simply, two comparison circuits 211 and 212, two switch circuits 221 and 222, two resistors R1 and R2, and two voice storage circuits 231 and 232 are illustrated.

A first comparison circuit 211 comprises a first comparator A1, a second comparator A2 and a first logic component N1. A positive input of the first comparator A1 and a negative input of the second comparator A2 are connected to the reference voltage circuit 30 respectively, to receive a first reference voltage Vrefl and a second reference voltage Vref2. A negative input of the first comparator A1 and a positive input of the second comparator A2 are connected together, and all connected to the signal measurement circuit 10, to receive the voltage signals. In one embodiment, value of the first reference voltage Vrefl exceeds that of the second reference voltage Vref2, which form a first reference voltage range. The logic component N1 is a logic AND gate that has two inputs connected to outputs of the first comparator A1 and the second comparator A2 respectively and outputs a first logic control signal. If the voltage signals output from the signal measurement circuit 10 do not fall in the first reference voltage range, the logic component N1 outputs a high logic signal, such as 3.3 V; if the voltage signal output from the signal measurement circuit 10 falls in the first reference voltage range, the logic component N1 outputs a low logic signal, such as OV.

The first switch circuit 221 comprises a transistor Q1 having a base connected to the logic component N1 to receive the first logic signal, an emitter grounded and a collector defined as an output of the first switch circuit 221 connected to the speaker 40 and a first voice storage circuit 231. The transistor Q1 is always switched on due to the resistor R1, and thus, the collector of the transistor Q1 is grounded. Accordingly, the first voice storage circuit 221 is shorted, such that corresponding audio signal stored therein cannot be output via the speaker 40. Only if the logic component N1 of the first comparison circuit 221 outputs the low logic level, the base of the transistor Q1 is dropped and the transistor Q1 is switched off. Thus, the first voice storage circuit 231 can output corresponding audio signal stored therein via the speaker 40.

The second comparison circuit 212, the second switch circuit 222 and the second voice storage circuit 232 have the same connections, structures and operations as the first comparison circuit 211, the first switch circuit 221 and the first voice storage circuit 231, thus description thereof is not included herein.

As is shown, the switch circuits of the present disclosure remain on, and only if the voltage signals indicating the power levels of the wireless signal fall in one of the reference voltage ranges, the corresponding switch circuit is switched off. Thus, an audio signal stored in a corresponding voice storage circuit can be output via the speaker, to provide power level information for the wireless signals.

In summary, the voice notification circuit 20 of the present disclosure comprises a plurality of predetermined reference voltage ranges, utilizing comparison circuits to determine whether the voltage signals indicating the power levels of the wireless signals fall in one reference voltage range, and controls a corresponding switch circuit to switch off. Thus, the audio signals stored in a corresponding voice storage circuit can be output via the speaker.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. A voice notification circuit to convert power levels of wireless signals into audio signals and broadcast the audio signals via a speaker, the voice notification circuit comprising:
a plurality of comparison circuits to compare the power levels of the wireless signals with a plurality of reference voltage ranges and output a plurality of control logic signals according to the comparisons;
a plurality of switch circuits connected to the comparison circuits respectively, to switch on/off based on the control logic signals;
a plurality of resistors each having one end to receive an external power source and the other end connected to a common node of the corresponding comparison circuit and the corresponding switch circuit, to turn the corresponding switch circuit on; and
a plurality of voice storage circuits connected to the switch circuits respectively, to store the audio signals, wherein when the power levels of the wireless signals match one of the reference voltage ranges, the corresponding switch circuit is switched off, and the corresponding voice storage circuit outputting a corresponding audio signal to the speaker.

2. The voice notification circuit as claimed in claim 1, wherein each of the comparison circuits comprises:
a first comparator with a positive input receiving a first reference voltage;
a second comparator with a positive input connected to a negative input of the first comparator, and a negative input receiving a second reference voltage; and
a logic component connected to the first comparator and the second comparator, to output the at least one logic control signal based on outputs of the first comparator and the second comparator.

3. The voice notification circuit as claimed in claim 2, wherein the first reference voltage and the second reference voltage form one of the reference voltage ranges, and the first reference voltage exceeds the second reference voltage.

4. The voice notification circuit as claimed in claim 2, wherein the logic component is an AND gate.

5. The voice notification circuit as claimed in claim 1, wherein each of the switch circuits comprises a transistor comprising a base connected to the other end of the corresponding resistor and also to receive the corresponding logic control signal, an emitter grounded, and a collector defined as an output and connected to the corresponding voice storage circuit.

6. An electronic device outputting a plurality of audio signals to denote power levels of wireless signals, comprising:
a signal measurement circuit to measure the power levels of the wireless signals and convert the result into voltage signals;
a voice notification circuit to convert the power levels of the wireless signals into the audio signals, comprising:
a plurality of comparison circuits to compare the power levels of the wireless signals with a plurality of reference voltage ranges and output a plurality of control logic signals according to the comparisons;
a plurality of switch circuits connected to the comparison circuits respectively, to switch on/off based on the control logic signals;
a plurality of resistors, each resistor with one end receiving an external power source and the other end connected to a common node of the corresponding comparison circuit and the corresponding switch circuit, to turn the corresponding switch circuit on; and
a plurality of voice storage circuits connected to the switch circuits respectively to store the audio signals, wherein when the power levels of the wireless signals fall in one of the reference voltage ranges, the corresponding switch circuit is switched off, and the corresponding voice storage circuit outputs one of the audio signals to the speaker;
a reference voltage circuit to provide a plurality of reference voltages to the signal measurement circuit; and
a speaker to transmit the at least one audio signal.

7. The electronic device as claimed in claim 6, wherein each of the comparison circuits comprises:
a first comparator with a positive input to receive a first reference voltage;
a second comparator with a positive input connected to a negative input of the first comparator, and a negative input to receive a second reference voltage; and
a logic component connected to the first comparator and the second comparator, to output the at least one logic control signal based on outputs of the first comparator and the second comparator.

8. The electronic device as claimed in claim 7, wherein the first reference voltage and the second reference voltage form one of the reference voltage ranges, and the first reference voltage exceeds the second reference voltage.

9. The electronic device as claimed in claim 7, wherein the logic component is an AND gate.

10. The electronic device as claimed in claim 6, wherein each of the switch circuits comprises a transistor comprising a base connected to the other end of the corresponding resistor and also to receive the corresponding logic control signal, an emitter grounded, and a collector defined as an output and connected to the corresponding voice storage circuit.
